(19) United States
(12) Patent Application Publication
(10) Pub. No.: US 2010/0042541 A1
(43) Pub. Date: Feb. 18, 2010

(54) FINANCIAL TRANSACTION SERVICE SYSTEM AND METHOD

(76) Inventors: Gyeong-Soo KANG, Seoul (KR); Hyeong-Jong YOO, Seoul (KR)

Correspondence Address: IPLA P.A., 3550 WILSHIRE BLVD., 17TH FLOOR, LOS ANGELES, CA, 90010, US

(21) Appl. No.: 12/538,408

(22) Filed: Aug. 10, 2009

(30) Foreign Application Priority Data
Aug. 12, 2008 (KR) 10-2008-0078726

(51) Int. Cl. G06Q 40/00

(52) U.S. Cl. 705/42; 705/44; 455/466

(57) ABSTRACT

A system and method for providing financial transaction service provides feedback service to a user in real time through SMS/ACS/CRM center, automatically classified according to approval rejection type, when financial service transaction is rejected or financial service is stopped halfway for an arbitrary reason while the user is provided with financial service such as cash service or card loan service through a web, ATM, ARC or mobile device such that the user can re-use the financial service. When a user who wants to use financial service such as cash service or card loan service through ATM, ARS or mobile device cannot use desired financial service because of excess of cap, personal identification number error, rejection of transfer or stopping use of financial service halfway, it is determined whether the user corresponds to re-transaction rejection condition designated by a financial institution and provides the desired financial service to the user.

### CROSS REFERENCES

This application claims foreign priority under Paris Convention to Korean Patent Application No. 10-2008-0078726, filed Aug. 12, 2008 with the Korean Intellectual Property Office.

### BACKGROUND OF THE INVENTION

1. Field of the Invention

The present invention relates to a system and a method for providing financial transaction service, and more particularly, to a system and a method for providing financial transaction service, which provide feedback service to a user in real time through SMS(Short Message Service)/ACS(Automatic Calling System)/CRM(Customer Relationship Management) center, which are automatically classified according to approval rejection type, when financial service transaction is rejected or financial service is stopped halfway for an arbitrary reason while the user is provided with financial service such as cash service or card loan service through a web, ATM, ARC or mobile device such that the user can re-use the financial service.

2. Background of the Related Art

With the development of telecommunication networks, users perform financial transactions by using Internet banking service on a web, ATMs installed in banks or other spaces, mobile devices, or automatic response service or counselor service using ARS if the financial transactions are not required to be performed at teller's windows of banks.

When a user attempts to perform financial transaction through the aforementioned methods, a simple financial transaction rejection message is output and the financial transaction is ended if the personal identification number of the user is wrongly input more than once or the credit limit of the user is exceeded in cash service and card loan service.

Accordingly, the user cannot use financial service through an additional process when the financial transaction is ended.

Furthermore, users who desperately want to use financial service should personally call a CRM center and consult with a counselor about a process required for the users to use the financial service.

### SUMMARY OF THE INVENTION

Accordingly, the present invention has been made in view of the above-mentioned problems occurring in the prior art, and it is a primary object of the present invention to provide a system and a method for providing financial transaction service, which provide feedback service to a user in real time through SMS/ACS/CRM center, which are automatically classified according to approval rejection type, when financial service transaction is rejected or financial service is stopped halfway for an arbitrary reason while the user is provided with financial service such as cash service or card loan service through a web, ATM, ARC or mobile device such that the user can re-use the financial service.

To accomplish the above object of the present invention, according to the present invention, there is provided a system for providing financial transaction service, which includes a financial service terminal performing financial transaction service; a wired/wireless communication network; an approval system performing an approval process corresponding financial transaction service requested by many and unspecified users when the many and unspecified users are online connected thereto by using the financial service terminal through the wired/wireless communication network and request the financial transaction service; and a CRM center system receiving, storing and administrating information corresponding to an approval or unapproval performed by the approval system.

To accomplish the above object of the present invention, according to the present invention, there is also provided a method for providing financial transaction service, which includes a step (1) in which a CRM center system determines whether a user selects a cash service or card loan service through online connection (channel) using a home-page, CD/ATM, ARS or mobile device by using a financial transaction service terminal; a step (2) of providing user information to an approval system to check whether the service and channel are approved when the user selects the service and channel; a step (3) of performing a normal approval process to make a financial sale when it is determined that there is no approval rejection reason from the checking result; a step (4) in which the approval system rejects approval and interfaces information input through the online connection (channel) when it is determined that there is an approval rejection reason from the checking result; a step (5) in which the CRM center system determines whether the user is an object of TM by using the interfaced information; a step (6) in which the CRM center system selects a calling list, selects a distribution logic, pops up information corresponding to the user on the screen of a terminal of a service representative and transmits a call signal to the user when the user is an object of TM, sends a text message corresponding to the approval rejection reason to the user when the user is an object of SMS, and automatically informs the user of an available method when the user is an object of ACS; a step (7) of determining whether a call line is connected with the user; a step (8) of notifying the user of the reason why financial transaction service that the user wants is not provided to the user, providing information on a solution for receiving the financial transaction service to the user and providing the financial transaction service to the user when the user agrees to the solution; and a step (9) in which the CRM center system registers TM history information of the user after the financial transaction service is provided and ends the process.

The present invention can provide feedback service to a user in real time through SMS/ACS/CRM center, which are automatically classified according to approval rejection type, when financial service transaction is rejected or financial service is stopped halfway for an arbitrary reason while the user is provided with financial service such as cash service or card loan service through a web, ATM, ARC or mobile device such that the user can re-use the financial service.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 illustrates a configuration of a system for providing financial transaction service according to the present invention; and

FIG. 2 is a flowchart showing a method for providing financial transaction service according to the present invention.

### DETAILED DESCRIPTION OF THE PREFERRED EMBODIMENT

The present invention will now be described more fully with reference to the accompanying drawings, in which exemplary embodiments of the invention are shown.

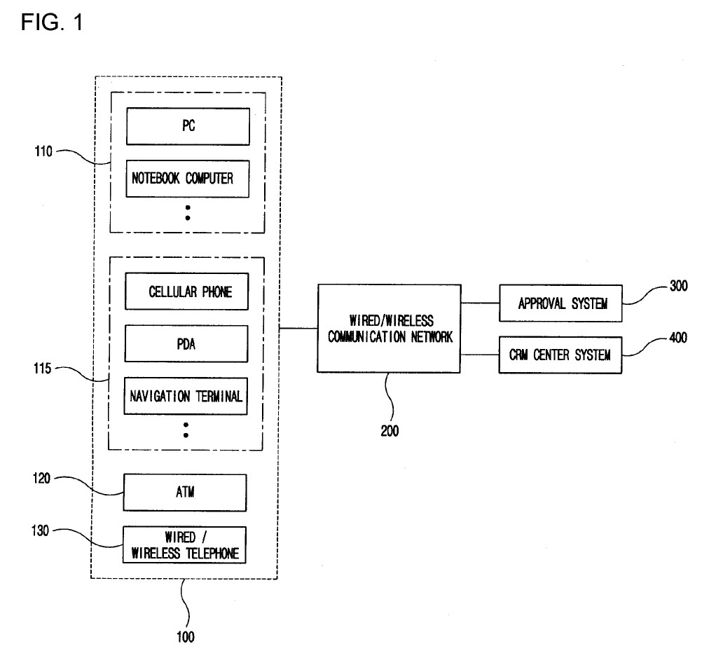

FIG. 1 illustrates a configuration of a system for providing financial transaction service according to the present invention. Referring to FIG. 1, the system for providing financial transaction service according to the present invention includes a financial service terminal 100 performing financial transaction service, a wired/wireless communication network 200, an approval system 300 performing approval processes corresponding to financial transaction services of many and unspecified users when the users online connect to the approval system 300 through the wired/wireless communication network 200 by using the financial service terminal 100 and request the financial transaction services, and a CRM center system 400 receiving, storing and administrating information corresponding to approval or unapproval performed by the approval system 300.

The financial service terminal 100 includes a user terminal 110 in which a program capable of executing financial transaction is installed, a mobile device 115 in which a program capable of executing financial transaction in an arbitrary space irrespective of the position of a user or time is installed, an ATM terminal 120 installed in a bank or arbitrary space, and a wired/wireless telephone 130 for receiving financial service in an ARS manner.

The user terminal 110 includes a PC located at home, a notebook computer, etc. The mobile device 115 includes a cellular phone, a PDA, a navigation terminal, etc.

The approval system 300 interfaces information such as a credit card number, a resident registration number, a personal identification number, a CVC (Card Validation Code) number, etc., input through the financial service terminal 100, checks financial service available state in real time and determines whether or not approval is performed.

The CRM center system 400 automatically excludes a user who does not need TM (Tele-Marketing) among objects of TM. The CRM center system 400 selects a TM item related to personal identification number error, a TM item related to error with respect to excess of cap and a TM item related to other errors, generates a calling list and connects a call line with a corresponding user according to the generated calling list.

The CRM center system 400 provides information on objects of TM on a terminal of a service representative in a pop-up manner.

The CRM center system 400 sends an SMS message to an object of TM to which a call line is not connected. When a call is connected to an object of TM, the CRM center system 400 generates call history information from the contents of the call and stores the call history information.

A method for providing financial transaction service through the aforementioned system for providing financial transaction service system will now be explained.

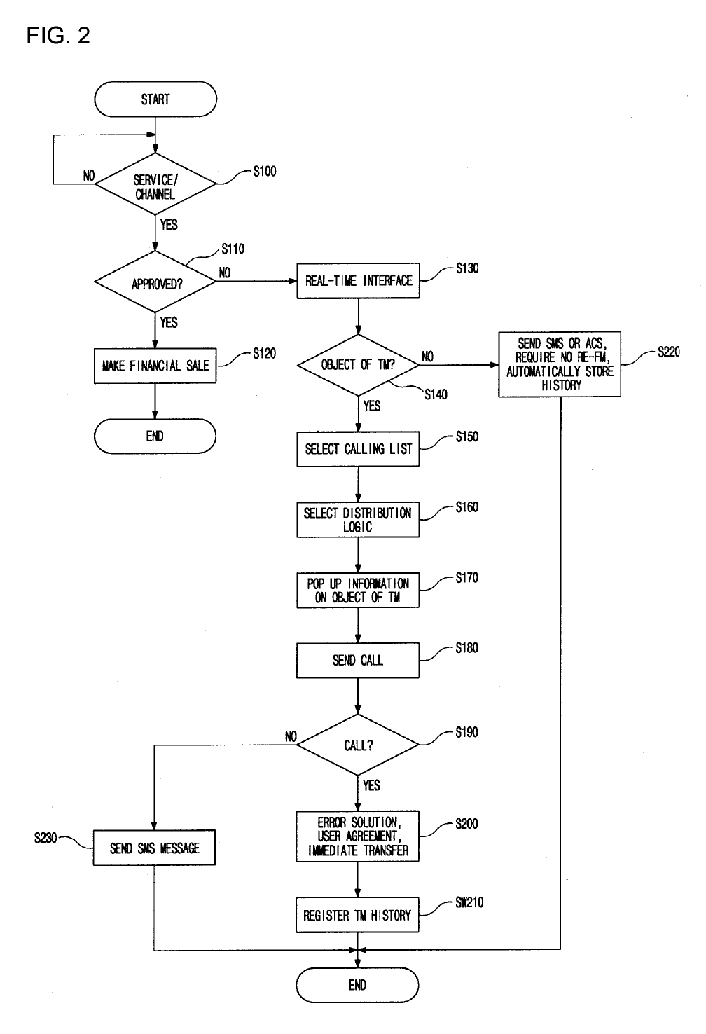

FIG. 2 is a flowchart showing the method for providing financial transaction service according to the present invention. Referring to FIGS. 1 and 2, the CRM center system 400 determines whether a user selects cash service or card load service through online connection (channel) using a home page, CD/ATM, ARS or mobile device by using the financial transaction service terminal 100 in step S100. When the CRM center system 400 determines that the user selects the service and channel, the CRM center system 400 provides user information to the approval system 300 to check whether the service and channel are approved in step S110.

That is, the approval system 300 interfaces information such as a credit card number, a resident registration number, a personal identification number or a CVC number through the online connection (channel) to check financial service available state of a corresponding credit card in real time and determines whether the credit card is approved. Furthermore, the approval system 300 checks dozens of approval rejection reasons such as wrong personal identification number, CVC conformity, excess of cap, arrearage, etc.

When there is no approval rejection reason, a normal approval process is performed to make a financial sale in step S120.

When there is an approval rejection reason, the approval system 300 rejects approval and interfaces information, which is input through the online connection (channel) and corresponds to the approval rejection reason, to the CRM center system 400 corresponding to a consultation system in real time when real-time TM is effective for the approval rejection reason in step S130. Here, an unnecessary object among objects of TM that are interfaced in real time is automatically excluded. That is, a user who is in arrears is excluded from the objects of TM because the user who is in arrears cannot use financial instruments. Furthermore, users who cannot use credit cards due to arrearage, credit rating decrease, credit measures or loss of credit card, users who are suspected to use lost cards or stolen cards, users who do not provide their telephone numbers and VIP users are excluded from the objects of TM. Although users who are in arrears are automatically excluded from the objects of TM, an SMS message is sent to a user who is in simple arrears when simple arrearage satisfies normal approval conditions.

Then, the CRM center system 400 determines whether the user corresponding to the interfaced information is an object of TM by using the interfaced information in step S140. When the user is an object of TM, a calling list is selected in step S150, a distribution logic is selected in step S160, the object of TM is popped up on the terminal of a service representative in step S170, and a call signal is transmitted to the corresponding user in step S180. Here, a text message corresponding to approval rejection reason is sent to the user when the user is an object of SMS, and the user is informed of an available method through an automatic call when the user is an object of ACS in step S180.

TM items for determining whether users are objects of TM may be classified into personal identification error related TM items when a wrong personal identification number is input more than once through ARS/web/ATM/Mobile terminal, TM items related to errors with respect to excess of cap, which include daily excess of cap of ATM, excess of total cap of ARS/web/ATM and no available money left in ARS/web/ATM, other error related TM items including ARS/web loan abandonment, ARS/web name inconsistency, return of bill and non-registration of automatic transfer account, and items with respect to stopping use of financial service halfway.

In the step S160, the distribution logic automatically assigns an initial case when a service representative logs in and includes a basic distribution logic automatically assigned to a service representative when consultation is ended after the initial case consultation history is stored, a logic controlling distribution priority for each TM item, which is able to control an approval rejection item for which immediate contact effect is maximized among approval rejection items to be input first as an object of TM, and a logic controlling distribution priority for each customer attribute, which is able to control a customer group for which immediate contact effect is maximized among various customers to be input first as an object of TM.

The step S170 in which the information corresponding to the object of TM is popped up will now be explained in more detail. When a service representative ends TM and pushes an end button, information corresponding to the next object of TM is automatically popped up on the screen of the terminal of the service representative and information corresponding to objects of TM that are interfaced in real time are automatically popped up on the screen even when user information such as resident registration numbers is not directly input.

It is determined whether the user is connected through a call line in step S190. When the user is connected through the call line, the user is informed of the reason why the user cannot be provided with the financial transaction service that the user wants, information on a solution for receiving the financial transaction service is provided to the user, and the financial transaction service is provided to the user when the user agrees to the solution in step S200. That is, when information on a user corresponding to an object of TM is popped up, the service representative confirms the type of the object of TM, and clicks a call button to connect a call line with the corresponding user to call the user.

In step S200, the user is notified of approval rejection reason corresponding to the reason for calling the user, and an immediately soluble part is solved. In addition, it is checked whether the user corresponds to an object of financial marketing, whether the user corresponds to an object of interest rate reduction in immediate transfer and whether the user corresponds to an object of cap increase, and the user is informed of marketing event to induce the user to use financial instruments. Finally, the user is notified that transfer account can be performed for the account of the user and the amount of money corresponding to the cash service or card loan service is transferred to the account of the user or an account that the user wants when the user agrees to the transfer account.

After the financial transaction service is provided to the user, the CRM center system 400 registers TM history information of the user and ends the process.

When the user is not classified as an object of TM in step S140, the CRM center system 400 automatically stores history information of the user as a member who does not need re-TM in step S220.

When the call line is not connected with the user in step S190, the CRM center system 400 sends an SMS message to a cellular phone of the user in step S230. Here, when the user is connected through a call line according to the SMS message, the service representative performs an identification process on the user and starts TM.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A system for providing financial transaction service, comprising:
a financial service terminal performing financial transaction service;
a wired/wireless communication network;
an approval system performing an approval process corresponding financial transaction service requested by many and unspecified users when the many and unspecified users are online connected thereto by using the financial service terminal through the wired/wireless communication network and request the financial transaction service; and
a CRM center system receiving, storing and administrating information corresponding to an approval or unapproval performed by the approval system.

2. The system of claim 1, wherein the financial service terminal comprises:
a user terminal in which a program capable of executing financial transaction is installed;
an ATM installed in a bank or an arbitrary space;
a wired/wireless telephone for receiving financial service in an ARS manner; and
a mobile device in which a program capable of executing financial transaction in an arbitrary space is installed.

3. The system of claim 1, wherein the approval system interfaces information such as a credit card number, a resident registration number, a personal identification number and CVC number, input through the financial service terminal, checks financial service available state in real time and determines approval.

4. The system of claim 1, wherein the CRM center system automatically excludes a user for which TM is not necessary among objects of TM and provides feedback service in real time through SMS/ACS/CRM center automatically classified according to approval rejection type.

5. The system of claim 1, wherein the CRM center system selects a TM item related to personal identification number error, a TM item related to error with respect to excess of cap, a TM item related to other errors and an item with respect to stopping use of financial service halfway, generates a calling list and connects a call line with a corresponding user according to the calling list.

6. The system of claim 1, wherein the CRM center system provides information corresponding to an object of TM on a terminal of a service representative in a pop-up manner.

7. The system of claim 1, wherein the CRM center system sends an SMS message to an object of TM to which a call line is not connected in a process of attempting to connect call lines with users, generates and stores the contents of a call as call history information when the call is connected.

8. A method for providing financial transaction service, comprising:
a step (1) in which a CRM center system determines whether a user selects a cash service or card loan service through online connection (channel) using a home-page, CD/ATM, ARS or mobile device by using a financial transaction service terminal;
a step (2) of providing user information to an approval system to check whether the service and channel are approved when the user selects the service and channel;
a step (3) of performing a normal approval process to make a financial sale when it is determined that there is no approval rejection reason from the checking result;
a step (4) in which the approval system rejects approval and interfaces information input through the online connection (channel) when it is determined that there is an approval rejection reason from the checking result;
a step (5) in which the CRM center system determines whether the user is an object of TM by using the interfaced information;
a step (6) in which the CRM center system selects a calling list, selects a distribution logic, pops up information corresponding to the user on the screen of a terminal of a service representative and transmits a call signal to the user when the user is an object of TM, sends a text message corresponding to the approval rejection reason to the user when the user is an object of SMS, and automatically informs the user of an available method when the user is an object of ACS;
a step (7) of determining whether a call line is connected with the user;
a step (8) of notifying the user of the reason why financial transaction service that the user wants is not provided to the user, providing information on a solution for receiving the financial transaction service to the user and providing the financial transaction service to the user when the user agrees to the solution; and
a step (9) in which the CRM center system registers TM history information of the user after the financial transaction service is provided and ends the process.

9. The method of claim 8, wherein unnecessary objects among objects of TM that are interfaced in real time are automatically excluded and feedback service is provided in real time through SMS/ACS/CRM center automatically classified according to approval rejection type in the step (4).

10. The method of claim 8, wherein it is checked whether the user is an object of financial marketing event, it is checked whether the user is an object of interest rate reduction in immediate transfer, it is checked whether the user is an object of cap increase, and the user is informed of the marketing event to induce the user to use the marketing event after the information on the solution is provided in the step (8).

11. The method of claim 8, wherein when the service representative ends TM and pushes an end button, information corresponding to the next object of TM is automatically popped up on the screen of the terminal of the service representative, and information corresponding to objects interfaced in real time are automatically popped up on the screen even when user information such as resident registration numbers is not directly input.
